(19) United States
(12) Patent Application Publication
(10) Pub. No.: US 2014/0223379 A1
(43) Pub. Date: Aug. 7, 2014

(54) DISPLAY APPARATUS FOR DISPLAYING A THUMBNAIL OF A CONTENT AND DISPLAY METHOD THEREOF

(71) Applicant: SAMSUNG ELECTRONICS CO., LTD., Suwon-si (KR)

(72) Inventors: So-young SHIN, Hanam-si (KR); Ji-bum MOON, Seoul (KR); Hyeon-ji LEE, Seoul (KR)

(73) Assignee: SAMSUNG ELECTRONICS CO., LTD., Suwon-si (KR)

(21) Appl. No.: 14/175,450

(22) Filed: Feb. 7, 2014

(30) Foreign Application Priority Data
Feb. 7, 2013 (KR) 10-2013-0013966

(51) Int. Cl. G06F 3/0482; G06F 3/0484

(52) U.S. Cl. CPC G06F 3/0482; G06F 3/04842
USPC 715/838

(57) ABSTRACT

A display apparatus is provided. The display apparatus includes a storage configured to store a content, a display configured to display a thumbnail image of the content, and a controller configured to sequentially change the thumbnail image at a predetermined time interval by using a plurality of images extracted from the content. Therefore, the display apparatus displays a thumbnail, and thus provides a user with a convenient operation of the apparatus so that the user is able to intuitionally understand the details of the content.

### CROSS-REFERENCE TO RELATED APPLICATIONS

This application claims priority from Korean Patent Application No. 10-2013-0013966, filed in the Korean Intellectual Property Office on Feb. 7, 2013, the disclosure of which is incorporated herein by reference, in its entirety.

### BACKGROUND

1. Field

The exemplary embodiments generally relate to a display apparatus and a display method. More particularly, the exemplary embodiments relate to a display apparatus which displays a thumbnail of a content, and a display method thereof.

2. Description of the Prior Art

In recent times, according to the ongoing development of electronic technologies, display apparatuses performing various functions are being developed. Such display apparatuses are being developed in various sizes, for example, from a portable display apparatus with a small screen to a display apparatus with a large screen like an electronic bulletin board. A large-screen display apparatus is suitable for displaying a plurality of contents on a screen.

Existing display apparatuses display a list of contents by using text or a small image. In the case of displaying a contents list in a form of text or a small image, it is possible to quickly display the contents list on a screen. However, in this case, a user is often unable to intuitively recognize details of the content.

Accordingly, in the field of display apparatuses, there is a growing need to develop a technology that fully displays information relating to content, and allowing a user to intuitively recognize details of the content.

### SUMMARY

An aspect of the exemplary embodiments relates to a display apparatus which displays a content by using a thumbnail so that a user is able to intuitively recognize details of the content, and a display method thereof.

According to an exemplary embodiment, a display apparatus may include a storage configured to store a content, a display configured to display a thumbnail image of the content, and a controller configured to sequentially changes the thumbnail image at a predetermined time interval, by using a plurality of images extracted from the content.

When a content execution command to the thumbnail image is inputted, the controller displays a content which corresponds to the thumbnail image, and when the content is closed, the controller may store in the storage information related to a last page which has been displayed.

When a re-execution command is inputted to the thumbnail image, the controller may display pages starting from the last page on the display.

The controller may sequentially change the thumbnail image by using each page from a first page to the last page of the content.

When a content execution command to the thumbnail image is inputted, the controller may display pages on the display starting from a page which has been displayed as the thumbnail image at the time when the content execution command is received.

The controller may be configured to display the thumbnail image in a first area on a screen of the display, and when a cursor is disposed on the thumbnail image, the controller may be configured to display an enlarged thumbnail image in a second area on the screen of the display.

When an application is selected, the controller may be configured to display on the display a plurality of thumbnail images which correspond to each of entire contents which are executable in the selected application.

According to an exemplary embodiment for achieving the aforementioned purpose, a display method includes extracting a plurality of images from a content, and displaying a thumbnail image by sequentially changing the thumbnail image according to a predetermined unit by using the plurality of images.

The display method may further include, displaying a content which corresponds to the thumbnail image, and when the content is closed, storing information of a last page which has been displayed when a content execution command to the thumbnail image is inputted.

The display method may further include displaying pages starting from the last page, when a re-execution command to the thumbnail image is inputted.

The display of a thumbnail image may include sequentially changing the thumbnail image by using each page from the first page to the last page of the content.

The display method may further include, displaying pages starting from the page which has been displayed as the thumbnail image at the time when the content execution command is received, when a content execution command to the thumbnail image is inputted.

The display method may further include displaying the thumbnail image in the first area on the screen of the display, and when a cursor is disposed on the thumbnail image, displaying an enlarged thumbnail image in the second area on the screen of the display.

When an application is selected, the display of a thumbnail image may include displaying a plurality of thumbnail images which correspond to each of the entire contents which are executable in the selected application.

Accordingly, the display apparatus displays a content by using a thumbnail image, so that a user is able to intuitively understand the details of the content. In addition, when inputting a re-execution command to a content, the display apparatus displays the last page or the last scene which was displayed in the previous operation, thereby increasing the convenience to a user.

An aspect of another exemplary embodiment may provide a display apparatus including a controller configured to sequentially change a thumbnail image at a predetermined time interval by using a plurality of images extracted from a content.

The display apparatus may further include a storage configured to store a content.

The display apparatus may further include a display configured to display a thumbnail image of the content.

The controller may be configured to display a content which corresponds to the thumbnail image on the display, in response to a content execution command regarding the thumbnail image being inputted, and in response to the content being closed, the controller is configured to control to store information related to a last page which has been displayed in the storage.

The controller may be configured to display pages starting from the last page on the display, in response to a re-execution command regarding the thumbnail image of the content being inputted.

The controller may be configured to sequentially change the thumbnail image by using each page of the content from a first page to a last page.

### BRIEF DESCRIPTION OF THE DRAWINGS

FIG. 1 is a block diagram which illustrates a configuration of a display apparatus, in accordance with an exemplary embodiment;

FIG. 2 is a view explaining a display screen of a display apparatus in accordance with an exemplary embodiment;

FIG. 3 is a view explaining a display of a thumbnail in accordance with an exemplary embodiment;

FIGS. 4-7 are views explaining a method of displaying various screens by a predetermined input in accordance with various exemplary embodiments; and

FIG. 8 is a flow chart of a display method in accordance with an exemplary embodiment.

### DESCRIPTION OF THE PREFERRED EMBODIMENTS

Hereinafter, various exemplary embodiments will be described in greater detail with reference to the accompanying drawings. In the following descriptions, well-known functions or constructions are not described in detail since they would obscure the invention with unnecessary detail. In addition, following terms were defined considering their functions in the exemplary embodiments, and they may vary according to an operator's intention or practice, etc. Accordingly, the terms should be defined based on the overall descriptions in the specification.

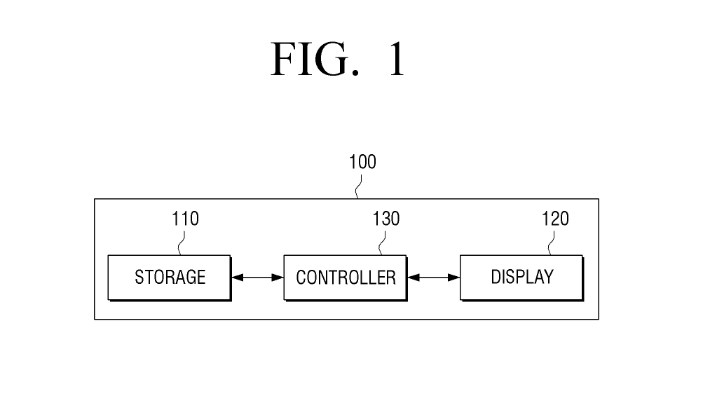

FIG. 1 is a block diagram which illustrates the configuration of a display apparatus in accordance with an exemplary embodiment.

Referring to FIG. 1, a display apparatus 100 includes a storage 110, a display 120, and a controller 130.

The display apparatus 100 may be implemented in the form of a tablet PC (Tablet Personal Computer), a Portable Multimedia Player (PMP), a Personal Digital Assistant (PDA), a SmartPhone, a monitor, a digital picture frame, a game machine, an electronic bulletin board, and a digital TV, etc.

The storage 110 stores a content. For example, a content may be a text file which was made by a word processor, a text file or an image file which is executed in a particular application, a moving image content, and a web-document which is connected to a web browser, etc. In addition, the storage 110 may store a control program and an application for controlling the display apparatus 100 or the controller 130.

When a user opens a content for an operation by executing an application, and ends the application or closes the content, the storage 110 may store information related to a last page which has been displayed. Information related to the last page may be a page number which identifies which page is the last page, a keyword of the last page, or an image of the last page, etc.

The storage 110, for example, may include a ROM, a RAM, or a memory card which is detachable/attachable to the display apparatus 100 (e.g., a SD card and a memory stick). In addition, the storage 110 may include a non-volatile memory, a volatile memory, a hard disk drive (HDD), or a solid state drive (SSD).

The display 120 displays a thumbnail image related to a content. When a content execution command is inputted on a thumbnail image, the display 120 displays a content which corresponds to the thumbnail image. The display 120 may be implemented as various display devices such as a Liquid Crystal Display Panel (LCD Panel), a Plasma Display Panel (PDP), an Organic Light Emitting Diode (OLED), a Vacuum Fluorescent Display (VFD), a Field Emission Display (FED), and an Electro Luminescence Display (ELD), etc.

The display 120 may be implemented as a common display panel without a touch-input function, or may be implemented as a touch display panel which is capable of recognizing a user's manipulation using a proximity sensor or a touch sensor. In response to a display being implemented as a touch display panel, the display may receive at least one touch gesture through a user's body (e.g., fingers, including thumbs) or by a recognizable input method (e.g., a stylus pen).

Such a user interface may include a certain touch area, a soft key, and a soft menu. The display 120 may transmit an electronic signal which corresponds to at least one touch gesture which is inputted through a user interface to the display 120 through an LCD controller (not illustrated). In addition, the display 120 may detect consecutive movements of a touch, and may transmit an electronic signal which corresponds to the consecutive or nonconsecutive movements of the touch, through the LCD controller.

The controller 130 generates a thumbnail image by extracting a plurality of images from a content. The controller 130 sequentially changes the thumbnail image by using the extracted plurality of images at a predetermined time interval. For example, in the case of a text content, the plurality of images may be each page from the first page to the last page, or may be each page from the first page to the last page when the text content is ended. The plurality of images may consist of user setting pages which are selected by a user. Or, the plurality of images may be list of information and keyword information, etc., related to a content.

A predetermined time interval may be set as 0.5 second and 1 second, etc. The predetermined time interval may be changed by a user, and may be set as 0 second. When the time interval is set as 0 second, a thumbnail may be composed of the first page, the last page, or a page from among the user setting pages.

When a command to execute content is inputted on a thumbnail image, the controller 130 may control the display 120 to display a content which corresponds to the thumbnail image. As specified above, in response to a user's command, the controller 130 may control an application to be executed, control a content to open or to be played, or control an application in operation to be ended or to a content to be closed. The controller 130 may control the storage 110 to store information of a last page which has been displayed when an application in operation is ended or a content in operation is closed.

Various exemplary embodiments regarding a screen and a thumbnail displayed on the display 120 will be described later.

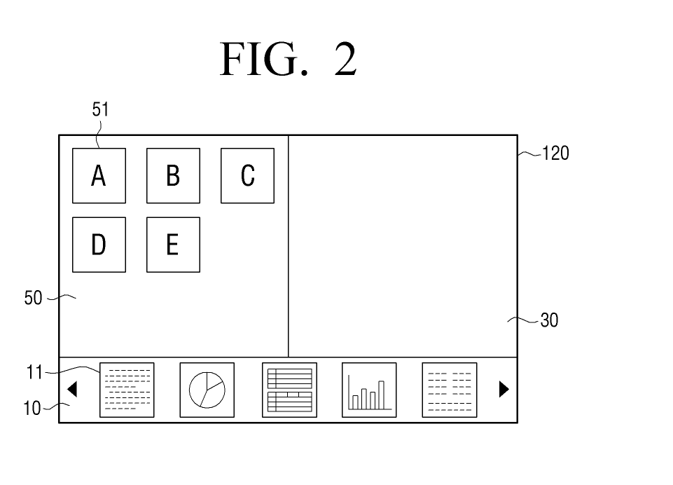

FIG. 2 is a view explaining a display screen of a display apparatus in accordance with an exemplary embodiment.

Referring to FIG. 2, a screen 120 of a display apparatus may be divided into three areas. These three areas refer to displaying menus or contents which are different from each other, and are not being physically divided. In the exemplary embodiments, an area where a thumbnail is displayed on a lower section of a screen is defined as a first area 10, a right area in an upper section of the first area 10 of the screen is defined as a second area 30 with reference to a direction in which a user watches a screen, and a left area in the upper section of the first area 10 of the screen is defined as a third area 50. The aforementioned classification of the areas is merely an exemplary embodiment, and is not limited to the classification of the screen area explained in FIG. 2.

The first area 10 may display a thumbnail. A thumbnail is a content-extracted image which sequentially displays a plurality of images extracted from a content at a predetermined time interval. Accordingly, a thumbnail varies with time like a moving image. In a lower section of a thumbnail, a file name of the thumbnail may be displayed. In addition, thumbnails may be displayed within a certain number, and in response to the number of thumbnails exceeding the number of thumbnails which are capable of being displayed, arrows are displayed in both sides, and the thumbnails may be changed right to left depending on which arrow is selected.

For example, in response to a right arrow being selected once, a leftmost thumbnail 11 among five thumbnails which are displayed disappears, the other four thumbnails move to the left one by one, and an unseen thumbnail may be displayed in the right end. Or, in response to a left arrow being selected during a predetermined time period, or in response to a double-click operation being performed, the five thumbnails which are currently displayed in a screen disappear, and next five thumbnails may be displayed. The thumbnails may be arranged according to a file name, or may be arranged in a most recently used order to correspond to a recently used file.

The second area 30 may be used as an operation area, or may display content summary information or may display an enlarged image of a thumbnail. The third area 50 may display an application or a folder installed in the display apparatus 100. The application or the folder may be displayed in the form of an icon.

Hereinafter, an exemplary embodiment of displaying a thumbnail in the display apparatus 100 will be described.

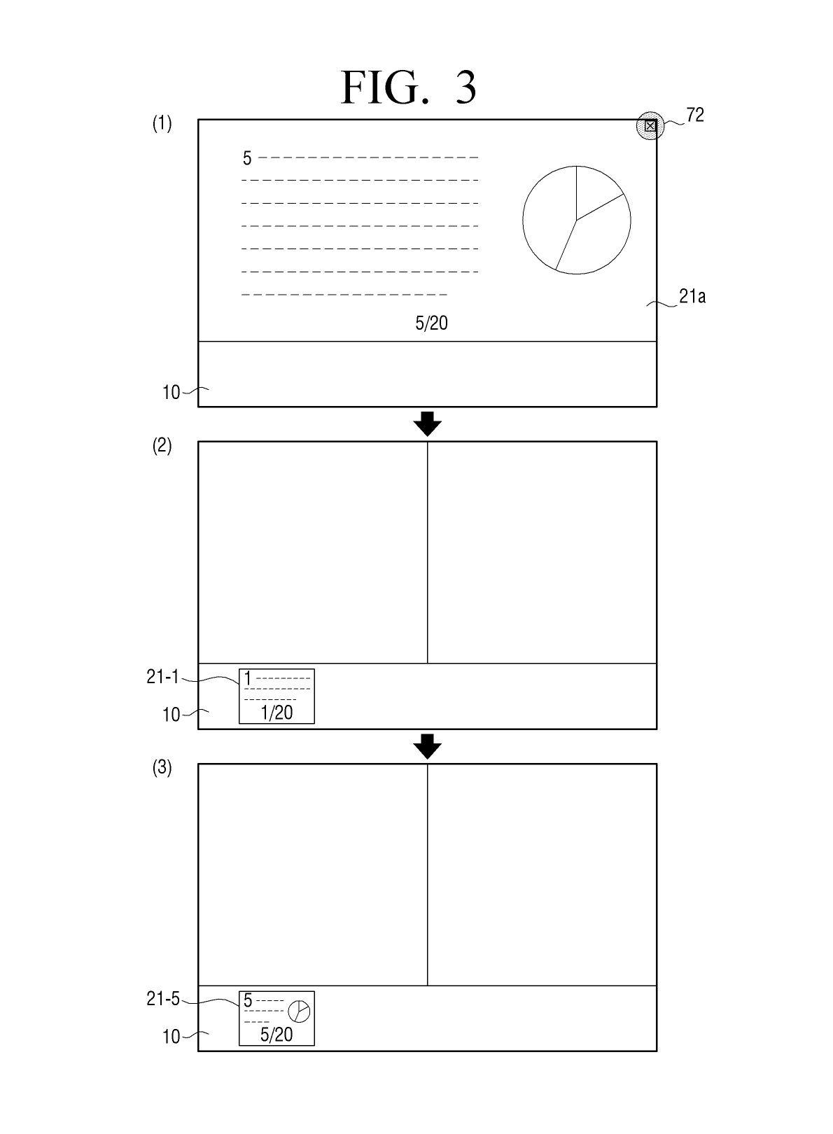

FIG. 3 is a view explaining a display of a thumbnail, in accordance with an exemplary embodiment.

In accordance with item (1) of FIG. 3, a first content 21a is displayed in the second area 30 and the third area 50. The displayed first content 21a has a total of 20 pages, and five pages are currently displayed. In a right upper section of the first content 21a, a closing window menu may be displayed. When the closing window menu is selected, a window of the displayed first content 21a is closed and an application is ended. For example, selecting a menu may be performed by a tap operation 72. In this case, the controller 130 obtains information related to a last page of the displayed first content 21a. In addition, the controller 130 extracts images from the first page to the last page at the time when the first content 21a is ended.

In accordance with item (2) of FIG. 3, a thumbnail of the first content 21a is displayed in the first area 10. The first area 10 of the display 120 displays a first page 21-1 extracted from the first content 21a for the first time. Based on a predetermined time interval, the first area 10 of the display 120 sequentially displays a second page, a third page, and a fourth page extracted from the first content 21a. The method of displaying the second, the third, and the fourth pages is the same as the method of displaying the first page 21-1, and thus is not explained in FIG. 3.

In accordance with item (3) of FIG. 3, a fifth page 21-5 of the first content 21a is displayed in the first area 10. The fifth page 21-5 of the first content 21a corresponds to the last page which is displayed when the first content 21a is ended. That is, the fifth page 21-5 of the first content 21a corresponds to the last image from among a plurality of images of a thumbnail which corresponds to the first content 21a. Accordingly, when a predetermined time elapsed after the fifth page 21-5 was displayed, a thumbnail displays the first page 21-1 again. By such method, a thumbnail may sequentially display images from the first page to the last page at the time when the first content 21a is ended. In response to the content being a moving image, a thumbnail may extract an image by 10 seconds, 1 minute, and 10 minutes, and may display the extracted image sequentially in the same manner above. That is, a thumbnail sequentially displays an image of a content so that a user is able to intuitively recognize the details of the content.

FIG. 3 explains a thumbnail which sequentially displays images from the first page to the last page at the time when a content is ended, but the display apparatus 100 may display a thumbnail by extracting pages from the first page to the last page of a content, by extracting unselected multiple pages according to a user's choice or a predetermined method, or by extracting a contents list or keyword information of a content. For example, the unselected multiple pages may be set as 10 pages and a chapter, etc.

The display apparatus 100 may execute various displays regarding a content by using a thumbnail which is displayed.

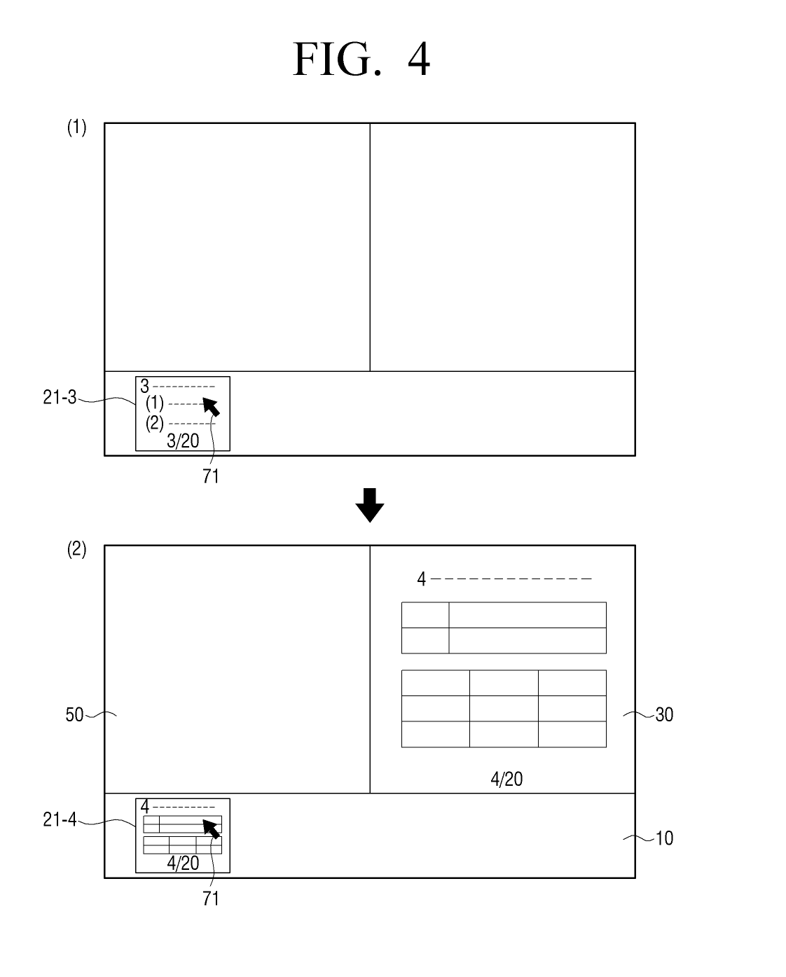

FIG. 4 is a view explaining a screen which is displayed when a cursor is disposed on a thumbnail.

Referring to item (1) of FIG. 4, a thumbnail which corresponds to a single content is displayed in the first area 10. A third page 21-3 of the thumbnail is currently displayed. A user moves and disposes a cursor 71 on the thumbnail. In response to the cursor 71 being located on the thumbnail for longer than a predetermined period of time, the display apparatus 100 enlarges and displays the thumbnail in the second area 30. For example, the predetermined time may be set as 0.5 second, 1 second, etc., and may be changed depending on a user's choice.

Referring to item (2) of FIG. 4, the second area 30 is enlarging and displaying a thumbnail. In item (1) of FIG. 4, the third page 21-3 of a thumbnail is displayed, and a certain amount of time has elapsed after a cursor was disposed. Accordingly, referring to item (2) of FIG. 4, a fourth page 21-4 of a thumbnail is displayed in the first area 10, and the cursor 71 is displayed on a thumbnail. The second area 30 displays the fourth page of a thumbnail which is enlarged by corresponding to a thumbnail display. The enlarged thumbnail may be changed and displayed according to change of an image of a thumbnail displayed in the first area 10.

Although it is not illustrated in item (2) of FIG. 4, the third area 50 may display an application or a folder. Item (2) of FIG. 4 explains an exemplary embodiment when an enlarged thumbnail is displayed in the second area 30, but the enlarged thumbnail may be displayed throughout the second and the third areas 30, 50. In addition, FIG. 4 explains an exemplary embodiment when an enlarged thumbnail is displayed when a cursor is located on a thumbnail during a certain time, but an enlarged thumbnail may be displayed by an operation in which a user clicks or touches a thumbnail once.

A thumbnail which is displayed in the first area 10 may open a corresponding content by an operation such as a double-click or a double-tap.

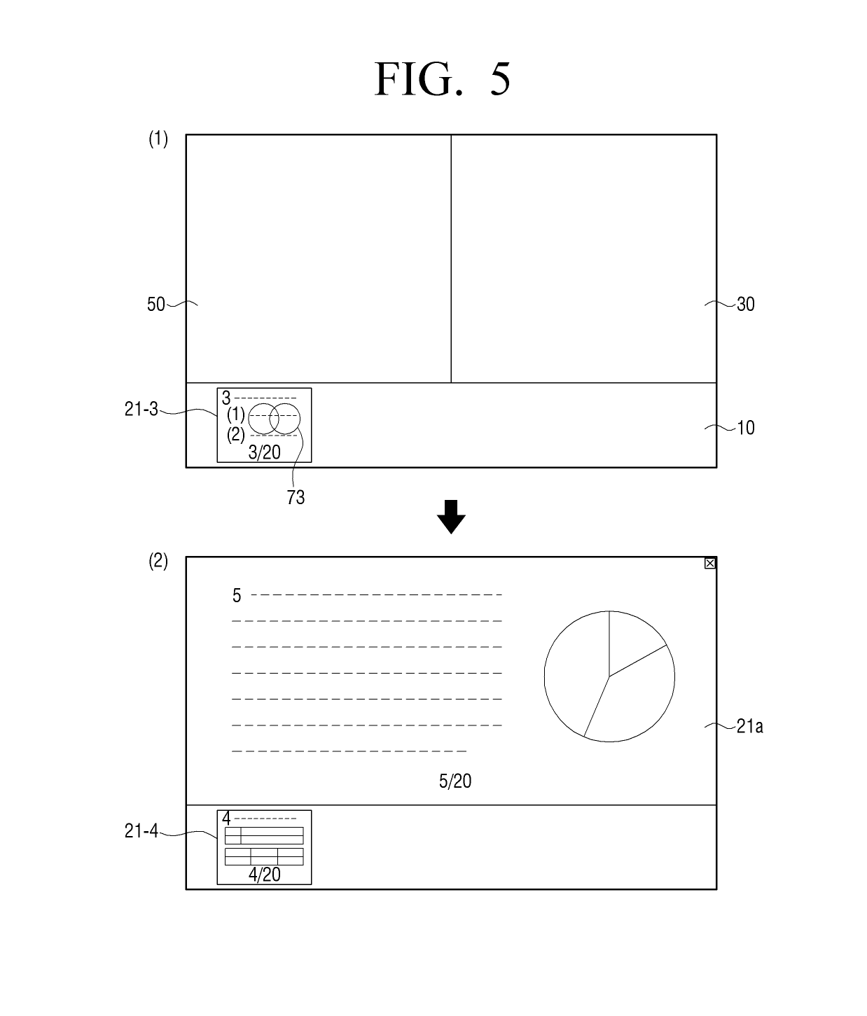

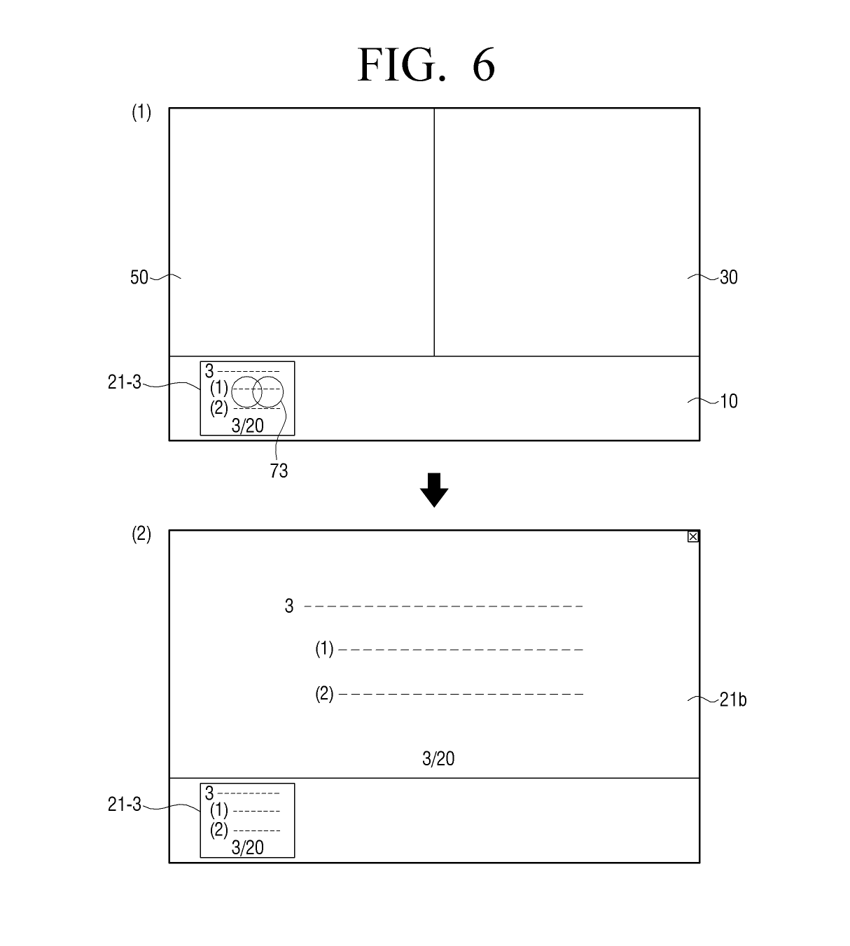

FIGS. 5-6 are views explaining an exemplary embodiment of opening a content in accordance with various exemplary embodiments.

Referring to item (1) of FIG. 5, the first area 10 displays a thumbnail at the time when the third page 21-3 of the first content is displayed. According to a user's command, an operation of opening a thumbnail is executed. Item (1) of FIG. 5 explains a double-tap 73 as an operation of opening a thumbnail. By the double-tap 73, the first content which corresponds to a thumbnail is opened.

Referring to item (2) of FIG. 5, a screen is displayed where the first content 21a is opened. The first content 21a may be displayed throughout the second and the third areas 30, 50. As occasion demands, opening the first content 21a may be executed only in the second area 30 or only in the third area 50. As described in FIG. 3, the first content 21a is composed of 20 pages, and was closed when five pages were displayed. Accordingly, the first content 21a may be opened so as to display the five pages which are the last pages which were displayed at the previous opening.

A thumbnail which corresponds to the first content 21a, which is displayed in the first area 10, may be displayed in the current state until the first content is closed again. That is, a thumbnail which corresponds to the first content may be displayed in the first area 10 while sequentially changing images from the first page to the fifth page.

In response to a user closing the first content 21a when seven pages are displayed, a thumbnail which is displayed in the first area 10 may be displayed while sequentially changing images from the first page to a seventh page.

FIG. 6 explains another exemplary embodiment of opening a content.

Referring to item (1) of FIG. 6, the first area 10 displays a thumbnail at the moment when the third page 21-3 of the first content is displayed. According to a user's command, an operation of opening a thumbnail is executed. This operation is the same as the operation explained above with respect to item (1) of FIG. 5.

Referring to item (2) of FIG. 6, a screen where the first content 21b is opened is displayed. The first content 21b may be displayed throughout the second and the third areas 30, 50. Referring to item (2) of FIG. 6, three pages of the first content 21b are displayed in the second and the third areas 30, 50. That is, the first content 21b displays a page at the moment when the double-tap 73 on a thumbnail is executed by a user.

A thumbnail which corresponds to the first content 21b is maintained in a state of displaying a page at the moment when the double-tap 73 is executed. That is, the thumbnail is maintained in a state of displaying the third page 21-3. In response to a user double tapping a thumbnail, the user is able to decide whether to display the last page at the previous ending, or whether to display a page at the moment of executing a double-tap. In addition, the user is able to select whether to maintain a thumbnail by displaying an image at the moment of executing a double-tap, or by displaying an image while sequentially changing the image.

An open page of the first content and a method of displaying a thumbnail when the first content is open may be variously set according to a user's choice or according to a set value of the display apparatus 100.

Types of thumbnails which are displayed in the first area 10 may be classified and rearranged according to which application is selected by the user.

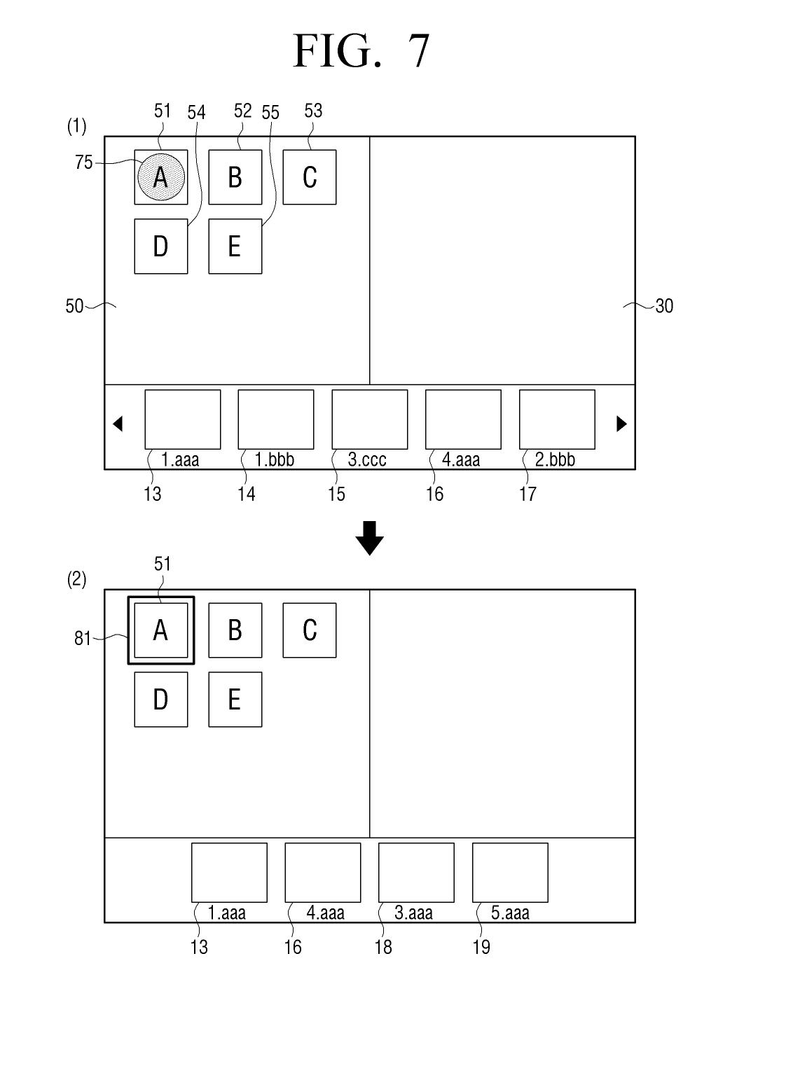

FIG. 7 is a view explaining a method of classifying and rearranging a thumbnail, in accordance with an exemplary embodiment.

According to item (1) of FIG. 7, the first area 10 displays five thumbnails. In FIG. 7, the number of thumbnails which are displayable in the first area 10 is supposed to be five, but the number of the displayable thumbnails may be variously set according to a size of a thumbnail, a size of the display apparatus 100, a size of the first area 10, etc.

Names of the five thumbnails are 1.aaa 13, 1.bbb 14, 3.ccc 15, 4.aaa 16, and 2.bbb 15, respectively. aaa, bbb, ccc in the above names are extensions, and signify that the files are contents which are executable by an A application, a B application, and a C application, respectively. In item (1) of FIG. 7, the extensions signify that the files are arranged in the order of recently used contents, when no application is selected. That is, 1.aaa 13 is the name of most recently opened content, and 2.bbb 17 is name of the fifth content, in the order of opening the content. The third area 50 displays an icon of an application which is executable in the display apparatus 100. In item (1) of FIG. 7, an A application 51, a B application 52, a C application 53, a D application 54, and an E application 55 are displayed. The A application 51 receives a user' command which is selected by one click. The one click is defined as a command of simply selecting an application, not a command for executing an application.

According to item (2) of FIG. 7, an edge of the A application 51 is brightly displayed by a selection operation. Or, the display apparatus 100 may display an icon of the A application 51 by changing a color, applying a shading, or changing an edge, etc., in order to show that the A application 51 is selected.

The display apparatus 100 may classify and rearrange a thumbnail which corresponds to a content which is connected to the A application 51, as the A application 51 is selected. That is, the display apparatus 100 may display a thumbnail image which corresponds to each of the entire contents which are executable in the selected A application, in the first area 10. Referring to item (2) of FIG. 7, only a thumbnail which corresponds to a content which is connected to the A application 51 is classified and displayed in the first area 10. That is, four thumbnails of 1.aaa 13, 4.aaa 16, 3.aaa 18, and 5.aaa 19 are displayed in the first area 10. Since thumbnails fewer than the maximum numbers of thumbnails which are displayable in the first area 10 are displayed, an arrow menu may be skipped. Item (2) of FIG. 7 explains a case of arranging thumbnails in the order in which they were recently opened. It is possible to rearrange the thumbnails in the order of a content name through a menu or a user's setting. For convenience in explaining, item (2) of FIG. 7 describes an extension of a content which corresponds to an application. However, an extension is only an exemplary embodiment, and thumbnails may be classified and rearranged according to a type of a connection program of an actual content.

As given above, a method of displaying a thumbnail which corresponds to a content and a method of displaying a content were described in accordance with various exemplary embodiments. Hereinafter, a flow chart of a displaying method will be described.

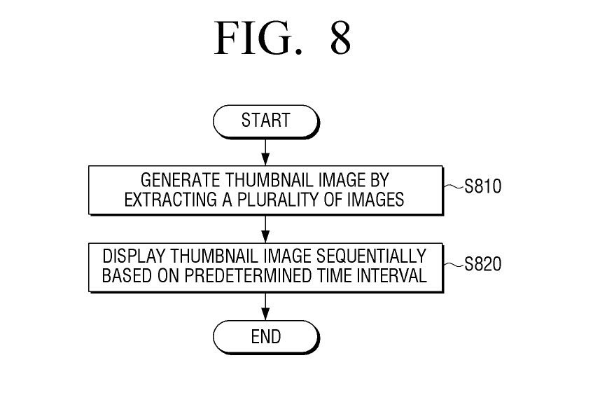

FIG. 8 is a flow chart displaying a method in accordance with an exemplary embodiment.

Referring to FIG. 8, a display apparatus extracts a plurality of images from a content which is stored and generates a thumbnail image (S810). The plurality of images may be unselective multiple pages based on pages from the first page to the last page of a content, pages from the first page to the last page of a content at the time of ending display of the content, and a user's definition. In addition, the plurality of images may be include a contents list or keyword information. In response to the content being a moving image, the plurality of images may be a frame in a predetermined unit from a first frame to a last frame. For example, a frame in a predetermined unit may be set as 10 seconds, 1 minute, and 10 minutes, etc. The display apparatus may extract the plurality of images and generate a thumbnail image when storing content even in response to the content not being the stored content.

The display apparatus sequentially changes and displays a thumbnail image based on a predetermined time interval by using a plurality of images (S820). A predetermined time interval may be set as 0.5 second or 1 second, etc., and may be set as 0 second. In response to the predetermined time interval being set as 0 second, a thumbnail may display only one image without changing an image.

A displaying method according to the aforementioned various exemplary embodiments may be provided to a display apparatus by being implemented as a program.

For example, by extracting a plurality of images from a content and a plurality of images, a non-transitory computer readable medium may be provided where a program of displaying a thumbnail image by sequentially changing an image at a predetermined time interval may be stored.

A non-transitory computer readable storage medium refers to a medium which stores data semi-permanently and is readable by a device, not a medium which stores data for a brief time such as a register, a cache, and a memory. To be specific, the aforementioned various applications or programs may be provided by being stored in a non-transitory computer readable medium such as a CD, a DVD, a hard disk, a Blue-ray Disk™, a USB, a memory card, and a ROM, etc.

As described above, desirable exemplary embodiments have been shown and described, but exemplary embodiments are not limited to the aforementioned particular exemplary embodiments, could rather be variously modified and achieved by those skilled in the art without deviating from the substance of the invention recited in the claims, and such modification should not be understood separately from the present invention.

What is claimed is:

1. A display apparatus comprising:
a storage configured to store a content;
a display configured to display a thumbnail image of the content; and
a controller configured to sequentially change the thumbnail image at a predetermined time interval by using a plurality of images extracted from the content.

2. The apparatus as claimed in claim 1, wherein the controller is configured to display a content which corresponds to the thumbnail image on the display, in response to a content execution command regarding the thumbnail image being inputted, and
in response to the content being closed, stores information related to a last page which has been displayed in the storage.

3. The apparatus as claimed in claim 2, wherein the controller is configured to display pages starting from the last page on the display, in response to a re-execution command regarding the thumbnail image of the content being inputted.

4. The apparatus as claimed in claim 3, wherein the controller is configured to sequentially change the thumbnail image by using each page of the content from a first page to a last page.

5. The apparatus as claimed in claim 1, wherein the controller is configured to display pages on the display starting from a page which has been displayed as a thumbnail image at a time when the content execution command is received, in response to a content execution command regarding the thumbnail image being inputted.

6. The apparatus as claimed in claim 1, wherein the controller is configured to display the thumbnail image in a first area on a screen of the display, and is configured to display an enlarged image of the thumbnail in a second area on the screen of the display, in response to a cursor being disposed on the thumbnail image.

7. The apparatus, as claimed in claim 1, wherein the controller, is configured to display a plurality of thumbnail images which correspond to each of entire contents which are executable in the selected application when an application is selected.

8. A display method comprising:
extracting a plurality of images from a content; and
displaying a thumbnail image by sequentially changing the thumbnail image at a predetermined time interval, by using the plurality of images.

9. The method as claimed in claim 8, further comprising:
displaying a content which corresponds to the thumbnail image in response to a content execution command to the thumbnail image being inputted, and storing information of the last page which has been displayed in response to the content being closed.

10. The method as claimed in claim 9, further comprising:
displaying pages starting from the last page in response to a re-execution command to the thumbnail image of the content being inputted.

11. The method as claims in claim 10, wherein displaying the thumbnail image comprises sequentially changing the thumbnail image of the content by using each page from the first page to the last page.

12. The method as claimed in claim 8, further comprising:
displaying pages starting from a page which has been displayed as the thumbnail image at the time when the content execution command is received, in response to a content execution command related to the thumbnail image being inputted.

13. The method as claimed in claim 8, further comprising:
displaying the thumbnail image in the first area on the screen of the display, and
displaying an enlarged thumbnail image in the second area on the screen of the display in response to a cursor being disposed on the thumbnail image.

14. The method as claimed in claim 8, wherein displaying the thumbnail image comprises displaying a plurality of thumbnail images which correspond to each of the entire contents which are executable in the selected application, in response to an application being selected.

15. A display apparatus comprising:
a controller configured to sequentially change a thumbnail image at a predetermined time interval by using a plurality of images extracted from a content.

16. The display apparatus of claim 15, further comprising a storage configured to store a content.

17. The display apparatus of claim 15, further comprising a display configured to display a thumbnail image of the content.

18. The apparatus as claimed in claim 17, wherein the controller is configured to display a content which corresponds to the thumbnail image on the display, in response to a content execution command regarding the thumbnail image being inputted, and
in response to the content being closed, the controller is configured to control to store information related to a last page which has been displayed in the storage.

19. The apparatus as claimed in claim 18, wherein the controller is configured to display pages starting from the last page on the display, in response to a re-execution command regarding the thumbnail image of the content being inputted.

20. The apparatus as claimed in claim 19, wherein the controller is configured to sequentially change the thumbnail image by using each page of the content from a first page to a last page.
